(19) United States
(12) Patent Application Publication
(10) Pub. No.: US 2006/0126080 A1
(43) Pub. Date: Jun. 15, 2006

(54) Light irradiating device and particle imaging device comprising the light irradiating device

(75) Inventor: Hideo Kusuzawa, Kobe-shi (JP)

Correspondence Address: BIRCH STEWART KOLASCH & BIRCH, PO BOX 747, FALLS CHURCH, VA, 22040-0747, US

(73) Assignee: SYSMEX CORPORATION, Kobe-shi (JP)

(21) Appl. No.: 11/281,512

(22) Filed: Nov. 18, 2005

(30) Foreign Application Priority Data
Nov. 30, 2004 (JP) 2004-347303

(51) Int. Cl. G01B 11/02

(52) U.S. Cl. 356/635

(57) ABSTRACT

An light irradiating device is described, a representative of which includes: a light source; a first projector lens system including, a first lens member for collimating a light beam emitted from the light source into a collimated light beam, a wavelength selecting unit for selectively transmitting a light having a spectral characteristic in which a central wavelength is not more than 450 nanometers and a half-value width is not more than 40 nanometers, a second lens member for condensing the light transmitted through the wavelength selecting unit, and an adjusting member comprising a transmitting part which has a predetermined sectional area and transmits the light beam condensed by the second lens member; and a second projector lens system for condensing the light emitted from the adjusting member and irradiating the light beam on an object.

### FIELD OF THE INVENTION

The present invention relates to an light irradiating device and a particle imaging device comprising the light irradiating device, more particularly to an light irradiating device for light irradiating a fine particle having a dimension of approximately 100 nanometers—several tens of micrometers as a measuring object and a particle imaging device comprising the light irradiating device.

### BACKGROUND

In order to image a fine particle having a dimension of not more than several tens of micrometers as a measuring object or analyze a shape thereof, it is essential to have a clear contrast in a periphery of the particle. In an optical microscope comprising an light irradiating device in which a coherent light source is adopted, a clear image can be obtained when the measuring object has a dimension larger than a wavelength of the light source, while an image of the measuring object having a dimension smaller than the wavelength of the light source cannot be obtained.

The reason for the aforementioned disadvantage is that an optical propagation function obtained by the coherent light source drastically drops to almost zero in a wavelength range. FIGS. 9A, 9B and 9C are known characteristic charts of a propagation coefficient with respect to a space propagation frequency obtained by the coherent light source. The propagation coefficient corresponds to a contrast of an outline part of the measuring object. As shown in FIG. 9A, a contrast of an image of the measuring object drastically changes based on the wavelength of the light source as a border, and the wavelength of the light source represents an identification limit of the dimension of the measuring object. In other words, the object not less than as substantially large as the wavelength can be accurately image-formed, while any object smaller than the wavelength cannot be image-formed at all. As another disadvantage, an interference pattern generated by a coherence makes it impossible to obtain a clear image.

On the other hand, the optical propagation function by the incoherent light source is gradually attenuated toward λ/2. A solid line A1 shown in FIG. 9B denotes a characteristic of the propagation coefficient with respect to the space propagation frequency by the incoherent light source. It is noted, however, that the aforementioned function denotes an optical resolution characteristic of an imaging optical system (light receiving optical system). Further, apartial coherent light source in which a coherence of an light irradiating light is enhanced has an intermediate characteristic between a coherent light and an incoherent light as shown in a dotted line B1 shown in FIG. 9B.

FIGS. 10A and 10B are illustrations of a known relationship between the coherence of the light irradiating light and a resolution of the image of the measuring object there by obtained. However, a modulation function of the object from the light source, in other words, a change of the light irradiated on the object is not taken in to account in the drawing. In FIG. 10A, a reference symbol L1 denotes an light irradiating light irradiated by the incoherent light source on a particle P1 from an arrow direction. An intensity of each light, which scatters from an outline part E1 of the particle P1, from the outline part E1 toward respective directions is denoted by a line S1. More specifically, the scattering intensity from the point E1 toward each direction is represented by a length of a distance from the point E1 to a point at which a line drawn in the relevant direction intersects with the line S1. Of the scattering lights, the scattering light within a range between a line C1 and a line D1 is led into the imaging optical system. In FIG. 10B, a reference symbol L2 denotes a partial coherent light that illuminates a particle P2. An intensity of each light that scatters from a outline part E2 toward respective directions is denoted by a line S2. Of the respective lights, the scattering light in a region between a line C2 and a line D2 is led into the imaging optical system. Here, an angle made by C1 and D1 is equal to an angle made by C2 and D2.

However, when the coherence of the light irradiating light is enhanced, a scattering efficiency of the particle to be measured in the outline part is correspondingly improved, which can be explained as follows.

In FIG. 10A, a total energy of the scattering light incidence the imaging optical system is represented by an area of a region where S1 is sandwiched between C1 and D1. On the other hand, in FIG. 10B, a total energy of the scattering light incidence the imaging optical system is represented by an area of the region where S2 is sandwiched between C2 and C2. Herein, the light irradiating lights L1 and L2 have an equal energy. As is clear from the comparison of the two areas, the energy of the scattering light from the partial coherent light source is larger than the energy of the scattering light from the incoherent light source. Therefore, the outline part of the particle to be measured can be more clearly imaged when the partial coherent light source is used than in the case of using the incoherent light source. This is consistent with the empirical fact that a light path of a laser beam passing through air appears to be illuminated because the fine particle in the air is scattered and diffracted, while a white light relatively does not appear to be as clear. The optical propagation function shows a characteristic shown in FIG. 9C when the diffracting/scattering effect in the outline part is taken into account.

As described, a resolving power is limited by the coherency of the light source when the numerical aperture number provided in the imaging optical system are not any different. In the case of using an optical microscope comprising the light irradiating device in which the incoherent light source is adopted, the image of the object to be measured becomes increasingly unclear as the size of the object is smaller and cannot be visually apprehended when the size is substantially the same as the wavelength of the light source. The contrast of the image of the object to be measured relative to the dimension of the object continuously changes. The image can be barely visually apprehended even in a range of the dimensions smaller than the wavelength of the light source.

Therefore, a method of recognizing even any finer measuring object by adopting the advantage of the incoherent light, that is the object having any dimension smaller than the wavelength of the light source can be discriminated, and the advantage of the coherent light, by which is the high contrast image can be obtained, is known.

An example of the method is an light irradiating device using the partial coherent light obtained by reducing the coherency of the light from the coherent light source. As an example of a constitution of the light irradiating device using the partial coherent light source is known a dark field light irradiating device in which a coherence reducing element is interposed in the light path of the laser beam and the coherence reduced laser beam is irradiated on an observing object so that the interference pattern, Fresnel diffraction, Franhoffer diffraction and the like resulting from the spatial and temporal coherence of the laser beam can be reduced and then a clearer image can be obtained (for example, see Japanese Patent Application Laid-Open (JP-A) No. 2000-131616).

Another example of the method is known an light irradiating optical system used for an optical microscope in which the incoherent light source is used to extract a wavelength of an extreme ultraviolet ray from a broad spectral characteristic of the light from the light source so that the coherence of the light irradiating light is enhanced and the coherence enhanced light irradiating light is irradiated on the measuring object (for example, see JP-A No. 2002-228935).

As described, the identification limit of the dimension of the measuring object depends on the wavelength and coherence of the light irradiating light, wherein the smaller measuring object can be discriminated with a higher possibility as the wavelength is shorter.

Of the laser light sources as the coherent light source, for example, an excimer laser or the like is known as a ultraviolet laser having a wavelength within a range of a short wavelength ultraviolet range, however is expensive.

Examples of the light source widely used for the optical microscope or the like as the incoherent light source include a halogen lamp, xenon lamp, mercury arc lamp in which a light emitting spectrum is more intensively distributed on the short wavelength side than the aforementioned lamps, and the like. However, when the measuring object has the size of several tens of micrometers as described earlier, a light emitting area of the light source is relatively large in any of the lamps in comparison to sizes thereof. Therefore, it is necessary to make various efforts to the light irradiating optical system in order to sufficiently increase a use efficiency of the light irradiating light for the object with respect to the light of the light source and obtain a clear image.

### SUMMARY

The present invention was implemented in order to solve the foregoing problems, and a main object thereof is to provide an light irradiating device having a simple structure and capable of achieving a high use efficiency of a light from a light source and obtaining a clear image of a minute subject and a particle imaging device comprising the light irradiating device.

An light irradiating device according to a first aspect of the present invention comprises: a light source; a first projector lens system including, a first lens member for collimating a light beam emitted from the light source into a collimated light beam, a wavelength selecting unit for selectively transmitting a light having a spectral characteristic in which a central wavelength is not more than 450 nanometers and a half-value width is not more than 40 nanometers, a second lens member for condensing the light transmitted through the wavelength selecting unit, and an adjusting member comprising a transmitting part which has a predetermined sectional area and transmits the light beam condensed by the second lens member; and a second projector lens system for condensing the light emitted from the adjusting member and irradiating the light beam on an object.

A particle imaging device according to a second aspect of the present invention is a particle imaging device for imaging a particle, comprising: a light source; an light irradiating device comprising a first projector lens system and a second proj ector lens system, the first proj ector lens system including, a first lens member for collimating a light beam emitted from the light source into a collimated light beam, a wavelength selecting unit for selectively transmitting a light having a spectral characteristic in which a central wavelength is not more than 450 nanometers and a half-value width is not more than 40 nanometers, a second lens member for condensing the light transmitted through the wavelength selecting unit, an adjusting member comprising a transmitting part which has a predetermined sectional area and transmits the light beam condensed by the second lens member, and the second projector lens system condensing the light beam emitted from the adjusting member and irradiating the light beam on an object; and

an imaging element for imaging the particle illuminated by the light irradiating device.

An light irradiating device according to a third aspect of the present invention comprises: a light source; a first projector lens system including, a first lens member for collimating a light beam emitted from the light source into a collimated light beam, a second lens member for condensing the collimated light transmitted through first lens member, and an adjusting member comprising a transmitting part which has a predetermined sectional area and transmits the light beam condensed by the second lens member; and a second projector lens system for condensing the light beam emitted from the adjusting member and irradiating the light beam on an object.

### BRIEF DESCRIPTION OF THE DRAWING

FIG. 1 is a schematic sectional view illustrating an example of a constitution of a particle imaging device including an light irradiating device according to a mode of the present invention (embodiment 1).

FIG. 2 is a schematic sectional view illustrating an example of a constitution of a particle imaging device including an light irradiating device according to another mode of the present invention (embodiment 2).

FIG. 3 is a perspective view illustrating an example of an external appearance of a particle image analyzing system including a particle imaging device according to a mode of the present invention.

FIG. 4 is an illustration of a schematic entire constitution of the particle image analyzing system shown in FIG. 3.

FIGS. 5A and 5B are illustrations of an example of an external appearance of a xenon flash lamp as a light source according to a mode of the present invention.

FIG. 6 is a graph showing a light emitting spectral characteristic of the xenon flash lamp as a light source according to the mode of the present invention.

FIGS. 7 are illustrations of an example of a lens characteristic having a large aberration and used in a projector lens system.

FIG. 8 are illustrations of an example of a lens characteristic having little aberration and used in the projector lens system.

FIGS. 9A, 9B and 9C are illustrations of a characteristic of a propagation coefficient relative to a space propagation frequency by a coherent light source according to a conventionally known technology.

FIGS. 10A and 10B are illustrations of a relationship between a coherence of an light irradiating light and a resolution of an image of a targeted object thereby obtained.

### DETAILED DESCRIPTION OF THE PREFERRED EMBODIMENTS

Hereinafter, an light irradiating device and a particle imaging device according to the present invention are described in detail referring to the drawings.

First is described an example of a constitution of a particle image analyzing system according to an embodiment of the present invention including the light irradiating device and the particle imaging device according to the present invention.

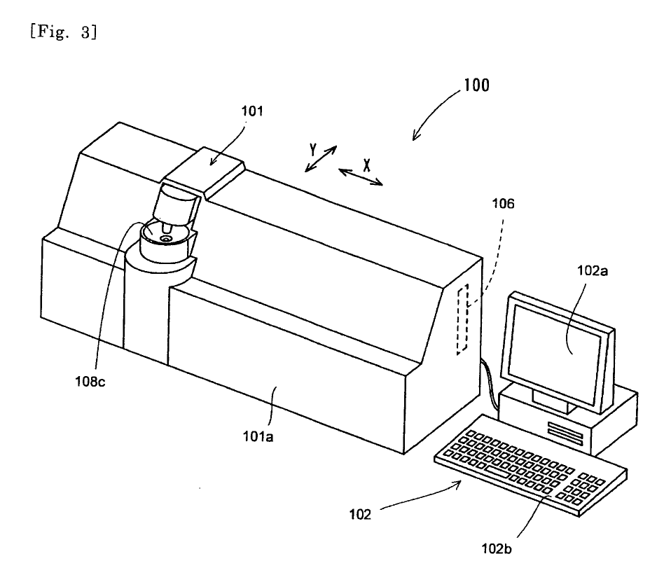

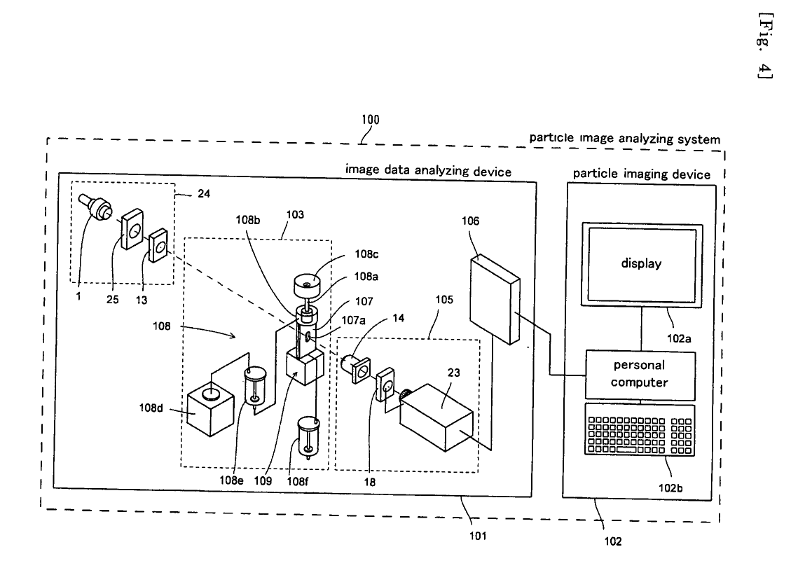

FIG. 3 is a perspective view illustrating an example of an external appearance of the particle image analyzing system. FIG. 4 is an illustration of a schematic entire constitution of the particle image analyzing system shown in FIG. 3.

A particle image analyzing system 100 in the drawings is used for the management of a quality of fine particles such as a fine ceramic particle, pigment and cosmetic powder. The particle image analyzing system 100 comprises, as shown in FIGS. 3 and 4, aparticle imaging device 101 andan image data analyzing device 102 electrically connected to theparticle imagingdevice 101.

The particle imaging device 101 is provided so as to image a particle in fluid and analyze the image of the particle. Examples of the particle analyzed by the particle imaging device 101 include the fine particles suchas the fine ceramic particle, pigment or cosmetic powder. Further, the particle imaging device 101 is entirely covered with a cover 101a as shown in FIG. 3. The cover 101a serves to block a light, and is provided with a heat insulating material for heat insulation (not shown) on an inner surface thereof so as to maintain a temperature inside. The particle imaging device 101 is provided with a Peltier element (not shown) for maintaining a temperature inside the particle imaging device 101 covered with the cover 101a at a predetermined degree (approximately 25° C.) and a fan (not shown). The temperature inside the cover 101a is controlled to stay at the predetermined degree using the Peltier element (not shown) and an air current is convected using the fan (not shown) to be equalized so that the temperature in the particle imaging device 101 can be maintained at the predetermined degree (approximately 25° C.). Thereby, a deviation generated in a focal distance in the imaging process due to the temperature change and a variation of characteristics such as a viscosity and a specific gravity of a sheath fluid, which will be described later, can be controlled.

The image data analyzing device 102 is provided so as to memorize and analyze the particle image processed by the particle imaging device 101 so that a size and a shape of the particle is automatically calculated and displayed. The image data analyzing device 102 comprises an image display unit (display) 102a for displaying the particle image and a personal computer (PC) comprising a keyboard 102b as shown in FIGS. 3 and 4.

The particle imaging device 101 comprises a fluid mechanism unit 103 for forming a flow of a particle suspension, an light irradiating device 24 for irradiating a light on the flow of the particle suspension, an imaging optical system 105 for imaging the flow of the particle suspension and an image processing unit 106 for cutting out the particle image as shown in FIG. 4. The light irradiating device 24 and the imaging optical system 105 are disposed facing to each other with the fluid mechanism unit 103 interposed therebetween. The fluid mechanism unit 103 comprises a flow cell 107 made of a transparent quartz, a supply mechanism section 108 for supplying the particle suspension and sheath fluid to the flow cell 107 and a support mechanism section 109 for supporting the flow cell 107. The flow cell 107 sandwiches the flow of the particle suspension by the flow of the sheath fluid flowing on both sides of the particle suspension to thereby convert the flow of the particle suspension into a flat flow. The flow cell 107 comprises a recessed part 107a having a vertically long shape in vicinity of a central position on an outer surface thereof on the imaging optical system 105 side as shown in FIG. 4.

The particle suspension flowing inside the flow cell 107 is imaged via the recessed part 107a of the flow cell 107. As shown in FIG. 4, the supply mechanism section 108 comprises a supply part 108b comprising a sample nozzle 108a for supplying the flow cell 107 with the particle suspension, a supply opening 108c for supplying the particle suspension into the supply part 108b (see FIG. 3), a sheath fluid container 108d for containing the sheath fluid, a sheath fluid chamber 108e for temporarily storing the sheath fluid and a waste fluid chamber 108f for storing the sheath fluid having passed through the flow cell 107.

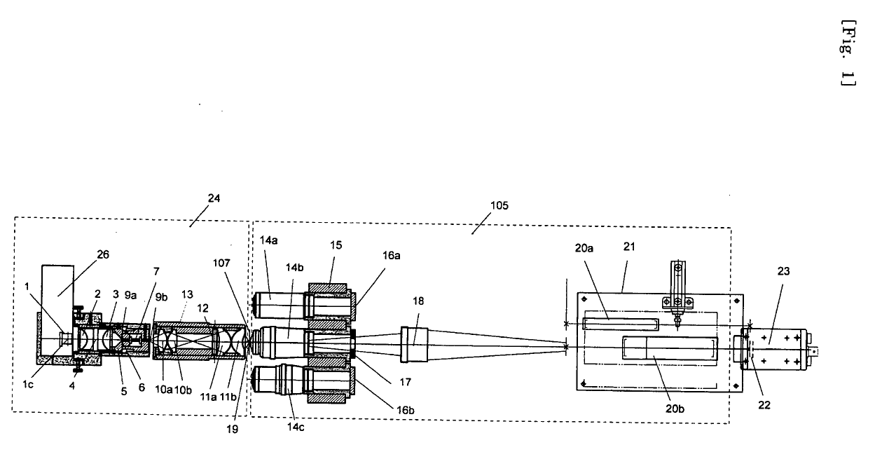

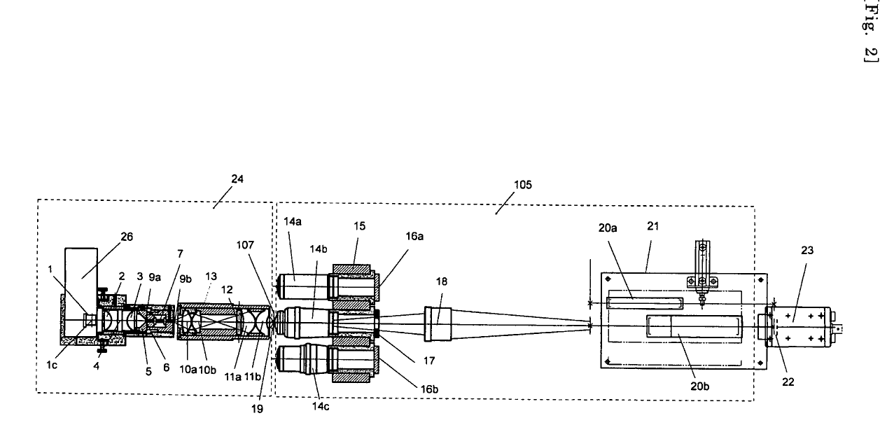

As shown in FIG. 3, the support mechanism unit 109 is movably driven by a third stepping motor not shown in an X direction along a light path and adapted to be capable of image-forming of the particle in the particle suspension flowing inside the flow cell 107 on a light receiving surface of a CCD 22 (see FIGS. 1 and 2) of an imaging unit 23.

The light irradiating device 24 comprises a xenon flash lamp 1 as a light source, a first projector lens system 25 and a second projector lens system 13. A more detailed constitution of the light irradiating device 24 will be described later. The imaging optical system 105 comprises an object lens unit 14, an image-forming lens unit 18 and an imaging unit 23. The object lens unit 14 is provided so as to enlarge an optical image of the particle in the particle suspension flowing inside the flow cell 107 illuminated by the light from the light irradiating device 24. The image-forming lens unit 18 is provided so as to form the optical image enlarged by the object lens unit 14. The imaging unit 23 is provided so as to image the optical image formed by the image-forming lens unit 18 and comprises a CCD camera. A more detailed constitution of the imaging optical system 105 will be described later.

Next, an operation of the particle imaging device 101 is described referring to FIGS. 3 and 4. First, the particle suspension fed to the supply opening 8c shown in FIGS. 3 and 4 is transported into the supply section 108b disposed in an upper part of the flow cell 107. The particle suspension in the supply part 108b is gradually pushed out into the flow cell 107 via an edge of the sample nozzle 108a provided in the supply part 108b. The sheath fluid is also fed into the flow cell 107 from the sheath fluid container 108d via the sheath fluid chamber 108e and the supply part 108b. Then, the particle suspension is sandwiched by the sheath fluid from both sides thereof and thereby pressed into a flat shape in terms of the fluid dynamics, and flows downward inside the flow cell from an upper direction in the flow cell 107.

As shown inFIG. 4, the particle suspension passes through the flow cell 107 and is thereafter discharged via the waste fluid chamber 108f. As described, the light from the light irradiating device 24 is irradiated on the flow of the particle suspension pressed into the flat shape in the flow cell 107 of the fluid mechanism unit 3 so that the image of the particle is obtained by the imaging unit 23 via the first object lens unit 14 and the second object lens 18 in the imaging optical system 105. Further, when a flat surface of the flow of the particle suspension is imaged by the imaging unit 23, a distance between a gravity center of the imaged particle and the light receiving surface of the CCD 22 of the imaging unit 23 can be substantively constant. Thereby, the particle image that is well focused can always be obtained irrespective of the size of the particle. An image signal from the CCD 22 of the imaging unit 23 (see FIGS. 1 and 2) is processed in the image processing unit 106 and then transmitted to the image data analyzing device 102 to be thereby displayed on the image display unit 102a.

Next, embodiments of the projector optical system constituting the light irradiating device 24 and the imaging optical system 105 including the object lens unit 14 and the image-forming lens unit 18 shown in FIG. 4 are described in detail below.

FIG. 1 is a schematic sectional view illustrating the light irradiating device according to the present invention applied to the particle image analyzing system shown in FIG. 4 and a particle imaging device including the light irradiating device according to a first embodiment of the present invention. In FIG. 1, the light irradiating device 24 is surrounded by a dotted line. In the constitution shown in FIG. 1, the xenon flash lamp 1 is used as the light source.

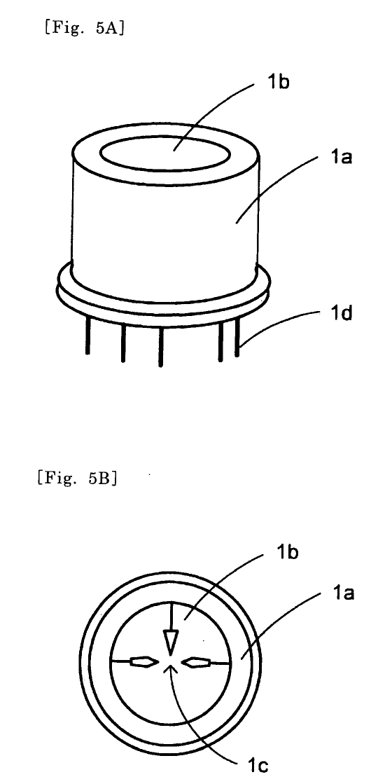

FIGS. 5A and 5B are illustrations of an external appearance of the xenon flash lamp 1 according to the present embodiment. To describe the lamp 1 shown in FIGS. 5A and B, a light emitting part 1c is housed in a case 1a formed from metal and having a cylindrical shape and has such a shape that the light irradiating light is emitted from a window 1b provided on a side of the case 1a. An inner surface of the case 1a is coated in black so that the light can be absorbed. Therefore, the light emitted outside the lamp 1 from the window 1b is mostly directly irradiated from the light emitting part 1c. A diameter of the case 1a is approximately 10 mm, and a height thereof is approximately 10 mm. A light emitting region of the light emitting part has a diameter of approximately 1 mm. The lamp 1 is mounted on a side of a light source housing 26, and the light irradiating light emitted from the light emitting part 1ctransmits through a first lens 2 as a first lens member disposed outside the lamp 1 via the window 1b and converted into a substantially parallel light. As the first lens 2, an aspherical lens is used in order to increase a use efficiency of the light irradiating light from the light source because the aspherical lens can realize a projector lens system having a favorable condensing characteristic, more specifically, a projector lens system in which a coma aberration is reduced, with a fewer lenses than in the case of using a spherical lens. Further, it is advantageous to increase a numerical aperture number (NA) of the first lens in order to increase the use efficiency of the light irradiating light from the light source. In the present embodiment, the numerical aperture number NA of the first lens 2 is 0.48.

In terms of efficiency, the numerical aperture number NA is preferably larger. However, when the opening ratio NA is increased, the condensing optical system including the first lens 1 is increased not only in size but also in terms of cost. Therefore, a preferable upper limit of the numerical aperture number is 0.75.

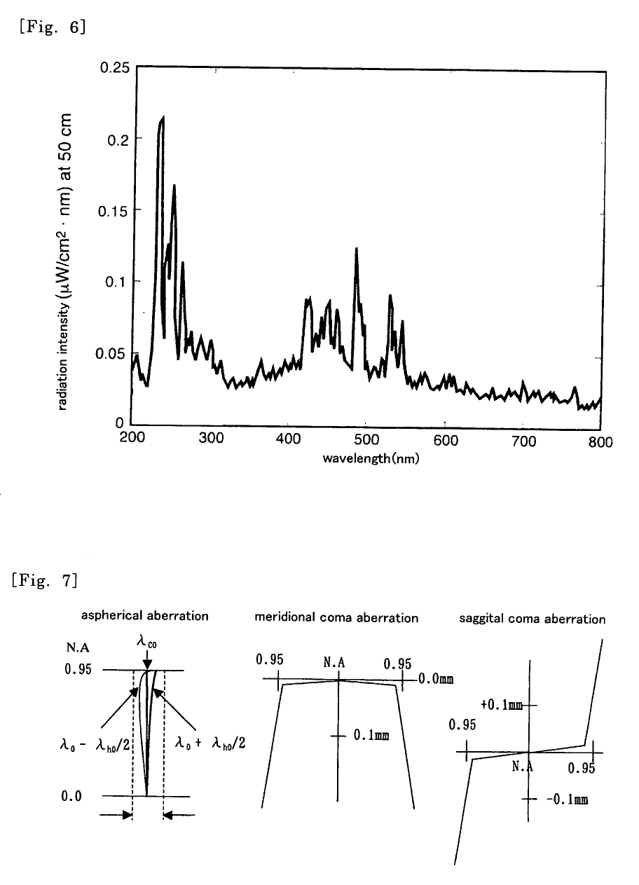

The light irradiating light that is substantially parallel via the first lens 2 transmits through a ultraviolet ray band pass filter 4 as a wavelength selecting unit. FIG. 6 is a graph showing an example of a light emitting spectral characteristic of the xenon flash lamp. As shown in FIG. 6, the xenon flash lamp as the light source has a light emitting spectral characteristic of a broad range including a infrared range whose wavelength is not less than 780 nanometers and a ultraviolet range whose wavelength is not more than 400 nanometers. The ultraviolet ray band pass filter 4 serves to extract a light of a short wavelength substantially corresponding to the ultraviolet range from the light of the light source having the light emitting spectral characteristic of the foregoing broad range. The ultraviolet ray band pass filter 4 has a band pass filtering characteristic in which a central wavelength is 400 nanometers and a half-value width is 10 nanometers, wherein an measuring object should have a size of approximately 300 nanometers. When the band pass filtering characteristic of the ultraviolet ray band pass filter 4 is changed, the light passing through the ultraviolet ray band pass filter 4 can have a spectral characteristic in which the central wavelength is in the range of 200-450 nanometers and the half-value width is 1-40 nanometers.

The central wavelength is preferably a smaller wavelength, that is a shorter wavelength, in terms of irradiating the fine particle and obtaining the high resolution image. The half-value width is preferably stay in a smaller range in terms of irradiating the fine particle and obtaining the high resolution image. However, when the range of the half-value width is narrowed, an energy ratio of transmitting light relative to a total energy of the emitting light, that is an efficiency, is deteriorated. Further, there is a certain relationship among the central wavelength of the wavelength selecting unit, half-value width and the coherency of the light transmitting through the wavelength selecting unit. Further, there is a certain relationship between the coherency and the dimension of the measuring object, which allows the high resolution image to be obtained. Therefore, the central wavelength and the half-value width should be set to optimum values in accordance with a demanded illuminance and dimension of the measuring object.

The ultraviolet ray light of a high coherence having transmitted through the ultraviolet ray band pass filter 4 transmits through a second lens 3 as a second lens member and is condensed on a focal point of the second lens 3. In the present embodiment, an aspherical lens is used as the second lens 3. When the aspherical lens is used, the projector lens system, in which the use efficiency of the light from the light source is improved and the coma aberration is reduced, can be obtained.

At a position where the image of the light emitting part 1c of the light source is formed, a pinhole 6 is provided as a transmitting part at an end of a condensing guide member 5 as an adjusting member so that the light enters from an incidence part 9a side of the pinhole 6 and emits from an emitting part 9b side thereof. Thereby, the emitting part 9b is regarded as a virtual point light source of the ultraviolet band light. A sectional diameter of the pinhole 6 according to the present embodiment is 0.1 millimeter. The diameter is substantially equal to a diameter of an illuminated region when the light irradiating object is illuminated. With this constitution, the use efficiency of the light from the light source can be increased. The sectional diameter of the pinhole 6 is preferably in the range of 0.1-2.0 millimeters.

The condensing guide member 5 is formed to have such a shape that a sectional inner diameter thereof in the vertical direction relative to an optical axis is gradually reduced from the second lend 3 toward the light incidence part 9a so that the light interrupted by the condensing guide member 5 and thereby not condensed on the pinhole 6 does not enter the light incidence part 9a as a stray light. Therefore, in FIG. 1, when a straight line denoting an end surface of the condensing guide member 5 from the second lens 3 through to the pinhole 6 is extended, the straight line intersects with the optical axis from the second lens 3 at a shape angle. The light that transmitted through the second lens 3 and is reflected on the end surface is further reflected on an end surface on the opposite side symmetrical to the end surface with respect to the optical axis and returned to the light source side. The light then enters the case 1a from the window 1b of the lamp 1 and is absorbed on the inner surface of the case 1a. As described, the inner surface of the case 1a is coated in black so as to absorb the light.

The light emitted from the emitting part 9b of the pinhole 6 passes through the second projector lens system 13 comprising a condenser lenses 10a, 10b, 11a and 11b and is condensed again, and there after irradiated on light irradiating object 19 flowing inside the flow cell 107 disposed in the illuminated region. The second projector lens system 13 is adapted in such manner that a size of the illuminated region is substantially equal to a size of a light emitting region of the emitting part 9b as the virtual light source of the second projector lens system 13. An area of the illuminated region is preferably 0.5-3 times as large as a sectional area of the pinhole 6. The second projector lens system 13 is provided with an opening number adjusting iris 12 for adjusting an opening ratio of the condenser lens on the light irradiating object side. The opening number adjusting iris 12 is driven by a first stepping motor not shown and is adapted to adjust an opening of the iris, that is the illuminance of the light irradiating light irradiated on the illumination subject 19.

The second projector lens system preferably comprises a small number of lenses in terms of obtaining a higher transmittivity of the light irradiating light, that is the increased use efficiency of the light from the light source. In order to realize the second projector lens system comprising a smaller number of lenses, the second projector lens system comprises the aspherical lenses. The aspherical lens can realize the projector lens system achieving the favorable condensing characteristic, that is the increased use efficiency of the light from the light source, with a fewer number of lenses than in the case of using the spherical lens. In general, the aspherical lens is often used in order to obtain the projector lens system in which the coma aberration is reduced. In the present embodiment, the coma aberration of the projector lens system is increased so that the formed image of the light from the light source is out of focus in order to evenly distribute an intensity of the illuminated region.

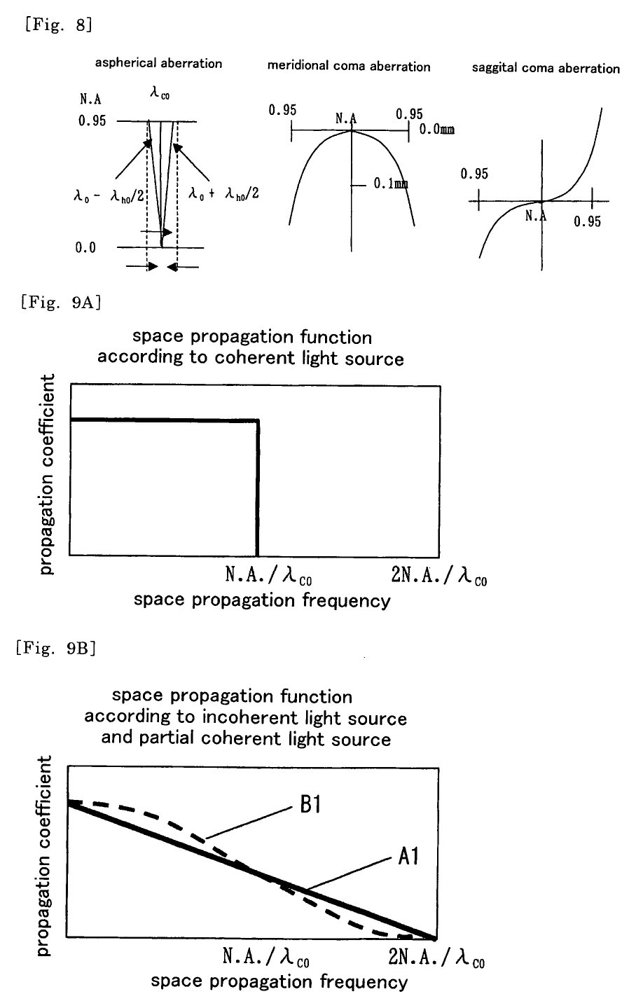

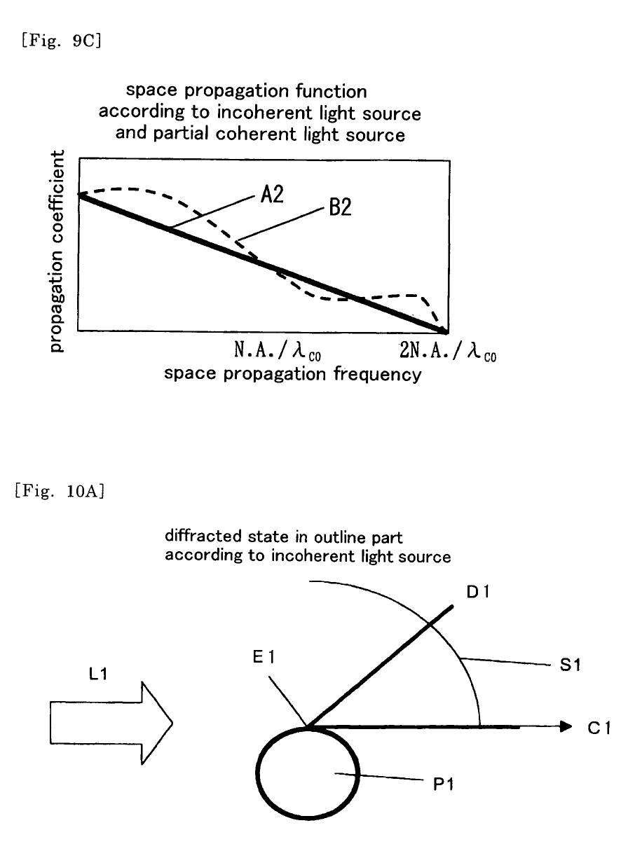

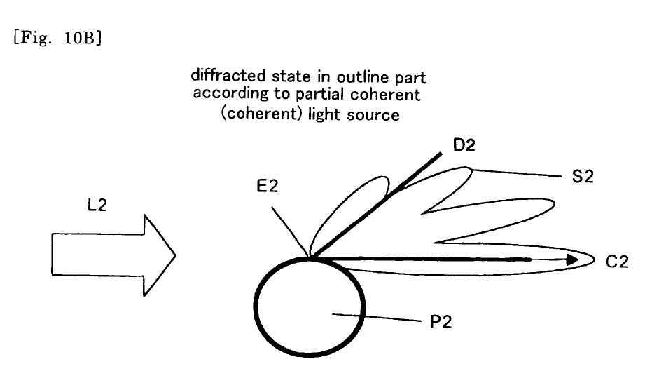

FIGS. 8 show aberration charts in the case of very little coma aberration, while FIGS. 7 are aberration charts in the case of a large coma aberration. As shown in FIGS. 8, the first projector lens system is adapted in such manner that a deviation range of a color aberration represented by an aspherical aberration is within a depth of field on the image-forming surface and the coma aberrations in the meridional plane and the saggital plane are minimized. As shown in FIGS. 7, the second projector lens system is adapted in such manner that the deviation range of the color aberration represented by the aspherical aberration is within the depth of field on the image-forming surface and the coma aberrations in the meridional plane and the saggital plane are increased.

On the opposite side of the projector optical system 13 with respect to the light irradiating subject 19 shown in FIG. 1 are provided first object lenses 14a, 14b and 14c of a switch-over type. In the present embodiment, magnifications of the first object lenses 14a, 14b and 14c are respectively 10 times, 60 times and 20 times. These first object lenses are adapted to be supported by a first object lens holder 15 and integrally move upward and downward. The upward and downward movements are driven by a second stepping motor not shown. Thereby, the lens of an optimum magnification in compliance with the dimension of the measuring object 19 can be selected.

Because a brightness of the illuminated measuring object 19 is different depending on the magnification of the object lens, a ND filter 16a for attenuating the light is provided at an end part of the first object lens 14a on the second object lens 18 side, and a ND filter 16b for attenuating the light is provided at an end part of the first object lens 14c on the second object lens 18 side so that the brightness of the image of the illuminated measuring object 19 can be equalized even though the magnification of the first object lens is different. Further, when the first object lens 14b having a largest magnification is selected, an opening number adjusting iris 17 is provided at an end part of the first object lens 14b on the second object lens 18 side so as to narrow down the light transmitting through the first object lens 14b because the image at the end part is beyond the range of the second object lens 18.

The light having transmitted through the first object lenses 14a, 14b and 14c transmits through the second object lens 18 and thereafter transmits through a relay lens 20a or 20b of the switch-over type. The light is then irradiated on the CCD 22 as the imaging element so as to form the image of the measuring object 19 on the light receiving surface of the CCD 22. The relay lenses 20a and 20b are housed in a relay lens housing 21 and respectively have the magnifications of 2 times a 0.5 times. The relay lenses 20a and 20b are integral with the relay lens housing 21 and are driven by a fourth stepping motor not shown so as to move upward and downward. Thereby, the magnification can be selected.

The image having transmitted through the relay lens 20a or 20b and formed on the CCD 22 is converted into an electrical signal of a pixel unit of the CCD and outputted from the imaging unit 23.

Next, a constitution of a particle imaging device including an light irradiating device according to a second embodiment of the present invention, which is different to the first embodiment, is described. FIG. 2 is a schematic sectional view illustrating an example of a constitution of the particle imaging device comprising the light irradiating device whose structure is different to the structure according to the mode shown in FIG. 1, wherein any component other than the light irradiating device is constituted in the same manner. As shown in FIG. 2, the constitution of the light path from the lamp 1 through to the condensing guide member 6 of the light irradiating device 24 is constituted in the same manner as in the embodiment 1. The light having transmitted through the pinhole 6 provided in the adjustment guide member 5 enters one end of a multi-mode optical fiber 7. The incident light with respect to the optical fiber 7 is transmits through the optical fiber 7 and is emitted from another end thereof. The emitting end of the optical fiber 7 constitutes the emitting part 9b. The light emitted from the emitting part 9b is irradiated on the light irradiating subject 19 via the projector lens system 13 constituted in the same manner as in the embodiment 1. A diameter of an effective sectional area of the multi-mode optical fiber 7 is 0.1 meters. The effective sectional area is substantially equal to the sectional area of the illuminated area when the light irradiating object subject is illuminated. The diameter of the effective sectional area of the multi-mode optical fiber 7 is preferably in the range of 0.1-2.0 millimeters.

When the multi-mode optical fiber 7 is used in the transmitting part, a luminous flux in the light emitting region of the emitting part 9b is more evenly distributed. Accordingly, the light irradiating light in the illuminated region on which the light of the emitting part 9b is projected is also equalized. Thereby, the illumination subject 19 can be more evenly illuminated.

In order to extract a predetermined wavelength range from the incoherent light source via a band filter as the wavelength selecting unit and irradiate the extraction result on the targeted object so as to obtain a clear image thereof, the spectral characteristic is preferably set so that the light irradiating light having transmitted through the band filter has a coherence length 1-300 times as long as the dimension of the targeted subject.

When the central wavelength of the spectrum of the light irradiating light is λC0, and the half-value width, that is a width between two points at which the intensity of the light emitting spectrum is 50% on both sides of a peak wavelength, is λh0, a central frequency fC0 corresponding to the central wavelength λC0 is represented by the following expression.

$${f}_{c 0} = \frac{c}{{λ}_{c 0}} \qquad NUMERAL EXPRESSION 1$$

(c: velocity of light under vacuum, approximately 3×10⁸ m/s)

A half-value frequency width corresponding to the half-value wavelength width λh0 is represented by the following expression.

$${f}_{h 0} = {λ}_{h 0} \cdot \frac{{f}_{c 0}}{{λ}_{c 0}} \qquad NUMERAL EXPRESSION 2$$

A coherence length H of the light irradiating light has the following relationship relative to the half-value wavelength width.

$$H = \frac{c}{{f}_{h 0}} = \frac{{λ}_{c 0}^{2}}{{λ}_{h 0}} \qquad NUMERAL EXPRESSION 3$$

The characteristic of the band filter of the wavelength selecting unit can be determined based on the foregoing aspects. For example, when the central wavelength of the light irradiating light λC0 is 400 nanometers, and the half-value length λh0 is 10 nanometers, the coherence length H is 16 micrometers. Therefore, the light irradiating device comprising the band filter of the foregoing characteristic is suitable for light irradiating an object of approximately 400−200 nanometers, which is approximately 1/40− 1/80 of the coherence length H, and obtaining a clear outline image of the object.

The embodiments described above are merely examples in all aspects and should not impose any restriction. A scope of the present invention is illustrated, not by the description of the embodiments, by the Scope of Claims, and includes any modification in the Scope of Claims and in the range and the significance of equivalence.

For example, the applicable light source is not limited to the xenon flash lamp, and may adopt, for example, a mercury arc lamp or a halogen lamp.

The ultraviolet ray band pass filter 4 as the wavelength selecting unit may be an optical filter manufactured according to a conventionally known method.

The shape of the condensing guide member 5 as the adjusting member is not limited to the shape that the sectional inner diameter thereof in the vertical direction relative to the optical axis is gradually reduced from the second lens 3 toward the light incidence part 9a. For example, a shape in which a pinhole is provided on a plate disposed in the vertical direction relative to the optical axis may be adopted.

The coma aberration of the second projector lens system is increased so that the coma aberration of the optical image relative to the measuring object is increased. However, the coma aberration of the first projector lens may be increased instead.

The numerical aperture number NA of the first lens 2 as the first lens member is 0.48 and preferably not more than 0.75, however, may be in the range of 0.30-0.75.

The second projector lens system 13 is adapted in such manner that the size of the illuminated region is substantially equal to the size of the light emitting region of the emitting part 9b as the virtual light source of the second projector lens system 13, however, may be 0.5 times-3 times as large as the size of the light emitting region of the emitting part 9b as the virtual light source of the second projector lens system 13.

In the light irradiating device 24, the ultraviolet ray bans pass filter 4 for selectively transmitting the light in which the central wavelength is 400 nanometers and the half-value width is 10 nanometers from all of the lights emitted from the xenon flash lamp 1 (light source) is used. However, the ultraviolet ray bans pass filter 4 may be replaced with a light source for emitting the light in which the central wavelength is 400 nanometers and the half-value width is 10 nanometers.

What is claimed is:

1. An light irradiating device comprising:
a light source;
a first projector lens system including, a first lens member for collimating a light beam emitted from the light source into a collimated light beam, a wavelength selecting unit for selectively transmitting a light having a spectral characteristic in which a central wavelength is not more than 450 nanometers and a half-value width is not more than 40 nanometers, a second lens member for condensing the light transmitted through the wavelength selecting unit, and an adjusting member comprising a transmitting part which has a predetermined sectional area and transmits the light beam condensed by the second lens member; and
a second projector lens system for condensing the light emitted from the adjusting member and irradiating the light beam on an object.

2. An light irradiating device as claimed in claim 1, wherein an optical image irradiated on the object is an image including a coma aberration.

3. An light irradiating device as claimed in claim 2, wherein a coma aberration in one of the first projector lens system and the second projector lens system is larger than a comma aberration in the other.

4. An light irradiating device as claimed in claim 1, wherein a lens numerical aperture number (NA) of the first lens member on the light source side is in the range of 0.30-0.75.

5. An light irradiating device as claimed in claim 1, wherein the transmitting part has a pinhole as the adjusting member.

6. An light irradiating device as claimed in claim 1, wherein the transmitting part has a multi-mode optical fiber as the adjusting member.

7. An light irradiating device as claimed in claim 1, wherein the first projector lens system comprises at least an aspherical lens.

8. An light irradiating device as claimed in claim 1, wherein the second projector lens system comprises at least an aspherical lens.

9. An light irradiating device as claimed in claim 1, wherein the second projector lens system comprises an opening iris for adjusting a numerical aperture number (NA).

10. An light irradiating device as claimed in claim 1, wherein the second projector lens system irradiates a light on the object in an area of an illuminated region 0.5-3 times as large as a sectional area of the transmitting part of the adjusting member.

11. A particle imaging device for imaging a particle, comprising:
a light source;
an light irradiating device comprising a first projector lens system and a second projector lens system, the first projector lens system including, a first lens member for collimating a light beam emitted from the light source into a collimated light beam, a wavelength selecting unit for selectively transmitting a light having a spectral characteristic in which a central wavelength is not more than 450 nanometers and a half-value width is not more than 40 nanometers, a second lens member for condensing the light transmitted through the wavelength selecting unit, an adjusting member comprising a transmitting part which has a predetermined sectional area and transmits the light beam condensed by the second lens member, and the second projector lens system condensing the light beam emitted from the adjusting member and irradiating the light beam on an object; and
an imaging element for imaging the particle illuminated by the light irradiating device.

12. Aparticle imaging device as claimed in claim 11, wherein the wavelength selecting unit transmits a light having a coherence length 1-300 times as long as a diameter of the particle.

13. An light irradiating device comprising:
a light source;
a first projector lens system including, a first lens member for collimating a light beam emitted from the light source into a collimated light beam, a second lens member for condensing the collimated light transmitted through first lens member, and an adjusting member comprising a transmitting part which has a predetermined sectional area and transmits the light beam condensed by the second lens member; and
a second projector lens system for condensing the light beam emitted from the adjusting member and irradiating the light beam on an object.

14. An light irradiating device as claimed in claim 13, wherein an optical image irradiated on the object is an image including a coma aberration.

15. An light irradiating device as claimed in claim 13, wherein a coma aberration in one of the first projector lens system and the second projector lens system is larger than a comma aberration in the other.

16. An light irradiating device as claimed in claim 13, wherein a lens numerical aperture number (NA) of the first lens member on the light source side is in the range of 0.30-0.75.

17. An light irradiating device as claimed in claim 13, wherein the transmitting part has a pinhole as the adjusting member.

18. An light irradiating device as claimed in claim 13, wherein the transmitting part has a multi-mode optical fiber as the adjusting member.

19. An light irradiating device as claimed in claim 13, wherein one of the first projector lens system and the second projector lens system comprises at least an aspherical lens.

20. An light irradiating device as claimed in claim 13, wherein the second projector lens system comprises an opening iris for adjusting a numerical aperture number (NA).
